(19) United States
(12) Patent Application Publication
(10) Pub. No.: US 2013/0100067 A1
(43) Pub. Date: Apr. 25, 2013

(54) SYSTEM AND METHOD FOR DETERMINING A NUMBER AND POSITION OF ONE OR MORE TOUCHES ON A TOUCH SCREEN

(71) Applicant: Christopher William DEWS, Fremont, CA (US)

(72) Inventor: Christopher William DEWS, Fremont, CA (US)

(21) Appl. No.: 13/281,297

(22) Filed: Oct. 25, 2011

(51) Int. Cl. G06F 3/044

(52) U.S. Cl. 345/174

(57) ABSTRACT

A method of determining a position and number of touches made on a capacitive touch screen device having capacitive touch sensor elements is provided. The method includes measuring capacitance values for each of the capacitive touch sensor elements, combining the capacitance values of each row of individual capacitive touch sensor to produce a horizontal sum of the capacitance values for each row, and combining the capacitance values of each column of individual capacitive touch sensor to produce a vertical sum of the capacitance values for each column. The method also includes determining a largest value of the horizontal sums and the vertical sums and normalizing the values of the vertical and horizontal sums to the largest vertical and horizontal sum, and applying one or more rules to the normalized horizontal and vertical sums to determine the number of touches made on the capacitive touch screen device.

### BACKGROUND

1. Technical Field

The present disclosure is related to resolving multiple touches made on a touch screen of a touch sensitive device. In particular, the present disclosure is related to a system and method for accurately detecting the number and positions of one or more touches made on a single-layer touch screen of a touch sensitive device.

2. Discussion of Related Art

Modern electronics often include a display and require a user interface to interface with or navigate on the display. Such user interfaces include touch screens or keypads for entering text into the device navigating through menus on the device, and selecting and accessing objects displayed on the screen or touch screen. As the drive to make electronics more mobile and reduce cost, touch screens have been made that use only a single sensing layer, which reduces the thickness of the touch screen and reduces cost by requiring only a single sensing layer to. Single layer touch screens often have problems with positional accuracy, particularly when resolving multiple touches.

The use of multiple touches on touch screen devices is increasing, as it provides more functionality than a single touch. Single touch capabilities are primarily limited to actions such as selecting a point on the touch screen (tap) and scrolling (slide or swipe). By adding the ability to detect and resolve multiple touches on touch screen devices, users are provided additional actions, such as pinching to zoom, rotation about a point, etc.

Resolving and accurately detecting multiple touches on a single layer touch screen has proved problematic. This is particularly problematic when the multiple touches are very close together on the touch screen. When multiple touches are close together on a touch screen the multiple touches may be detected by the same individual sensing elements that make up the touch screen, making it difficult to resolve the multiple touches into individual touches. This makes it difficult to not only determine the number of touches, but also the position of the touches, resulting in reduced positional resolution and accuracy.

What is needed is an improved method and system for determining the position and number of multiple touches made on a touch screen and, in particular, a single layer touch screen.

### SUMMARY

Consistent with some embodiments, there is provided a method of determining a number of touches made on a capacitive touch screen device having capacitive touch sensor elements arranged in columns and rows. The method includes measuring, by individual capacitive touch sensor elements of the touch screen device, capacitance values for each of the capacitive touch sensor elements, combining, by a controller central processing unit (CPU) of the capacitive touch screen device, the capacitance values of each row of individual capacitive touch sensor to produce a horizontal sum of the capacitance values for each row, and combining, by the controller CPU, the capacitance values of each column of individual capacitive touch sensor to produce a vertical sum of the capacitance values for each column. The method also includes determining a largest value of the horizontal sums and the vertical sums and normalizing the values of the vertical and horizontal sums to the largest vertical and horizontal sum The method also includes applying, by the controller CPU, one or more rules to the normalized horizontal and vertical sums to determine the number of touches made on the capacitive touch screen device.

Consistent with some embodiments, there is also provided a method for determining a position of one or more touches made on a capacitive touch screen device having capacitive touch sensor elements arranged in columns and rows. The method includes measuring, by individual capacitive touch sensor elements of the touch screen device, capacitance values for each of the capacitive touch sensor elements, combining, by a controller central processing unit (CPU) of the capacitive touch screen device, the capacitance values of each row of individual capacitive touch sensor to produce a horizontal sum of the capacitance values for each row, and combining, by the controller CPU, the capacitance values of each column of individual capacitive touch sensor to produce a vertical sum of the capacitance values for each column. The method also includes determining, by the controller CPU, a distribution of the vertical and horizontal sums for each touch, and determining, by the controller CPU, a position of a single touch and multiple touches by manipulating the sum values.

Consistent with some embodiments, there is further provided a circuit for determining the number and position of one or more touches made on a touch screen device having a plurality of capacitive touch sensor elements arranged in rows and columns and coupled to the circuit. The circuit includes a sensor multiplexer configured to receive capacitance values from the plurality of capacitive touch sensor elements, a capacitance-to-digital converter circuit configured to convert the received capacitance values to digital values, and a controller central processing unit (CPU). The controller CPU is configured to combine the capacitance values of each row of individual capacitive touch sensor to produce a horizontal sum of the capacitance values for each row, combine the capacitance values of each column of individual capacitive touch sensor to produce a vertical sum of the capacitance values for each column, and determine a number and position of one or more touches made on the touch screen device using the horizontal sums and the vertical sums.

These and other embodiments will be described in further detail below with respect to the following figures.

### BRIEF DESCRIPTION OF THE DRAWINGS

FIG. 1 is a diagram illustrating a system for determining the number and position of one or more touches made on a touch screen, consistent with some embodiments.

FIG. 2 is a diagram illustrating a controller, consistent with some embodiments.

FIG. 3 is a diagram illustrating a touch screen, consistent with some embodiments.

FIGS. 4A-4C are diagrams illustrating determining a number and position of one or more touches on a touch screen using vertical and horizontal sums, consistent with some embodiments.

FIG. 5 is a flowchart illustrating a method for determining a number of touches made on a touch screen, consistent with some embodiments.

FIGS. 6A-6G illustrate some of the rules that may be applied to the vertical and horizontal sums for determining a number of touches made on a touch screen, consistent with some embodiments.

FIG. 7 is a flowchart illustrating a method for determining a position of one or more touches on a touch screen device consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

Touch sensors may be of a variety of types, such as resistive, capacitive, and electro-magnetic types, and may be used for numerous applications, including selection, positioning, and navigation. One particular touch sensor, a capacitive touch sensor, may include a conductive material such as Indium Tin Oxide (ITO), aluminum or copper, which is sensitive to the capacitance of a sensor element. Capacitive touch sensors typically exhibit a precisely measured capacitance to the environment, and the human body also has capacitance to the environment. When a capacitive touch sensor's normal capacitance field (its reference state) is altered by another capacitance, e.g., by the touch or near touch (hereinafter, touches will also include near touches unless otherwise noted) of a person, capacitive touch sensors experience a change in capacitance which is recognized by the touch controller and processed mathematically. There are a variety of types of capacitive touch controllers, including capacitance-to-digital converters (CDC) which include Sigma-Delta modulators, charge transfer capacitive touch controllers, and relaxation oscillator capacitive touch controllers.

Conventional capacitive touch sensors use multiple electrode layers, including a transmitter electrode layer coupled to an excitation source, and a receiver electrode layer coupled to a capacitance-to-digital converter (CDC). In operation, there is an electric field formed between the transmitter electrode layer and the receiver electrode layer, as well as a stray electric field that extends from the transmitter electrode layer. The environment of the capacitive touch sensor changes when a human enters the stray electric field, with a portion of the electric field being shunted to ground instead of terminating at the receiver electrode layer, resulting in a decrease in capacitance at the receiver electrode layer. The resulting decrease in capacitance is detected by the CDC and converted to digital data which can be processed by a processor to provide an indication of a touch, a selection, or a position.

Capacitive touch sensors may also include single electrode layer capacitive touch sensors. Such single layer capacitive touch sensors include a single layer of conductive material, typically ITO, formed on an insulative substrate or printed circuit board (PCB). The single layer of conductive material forms a capacitive electrode. The single layer capacitive electrode may be protected from the environment using an overlay of protective material, which may be plastic or acrylonitrile-butadiene-styrene (ABS). The single layer electrode may then be coupled to circuitry for reading a capacitance value from the single layer electrode. Moreover, the single layer capacitive electrode may be divided into multiple electrodes by patterning the ITO into separate electrodes, each of which may have a separate coupling to circuitry, such as a CDC, for reading determining the capacitance value on each electrode. The separate electrodes may be patterned using etching or deposition techniques. Alternatively, multiple single layer capacitive electrodes may be formed on an insulative substrate or PCB.

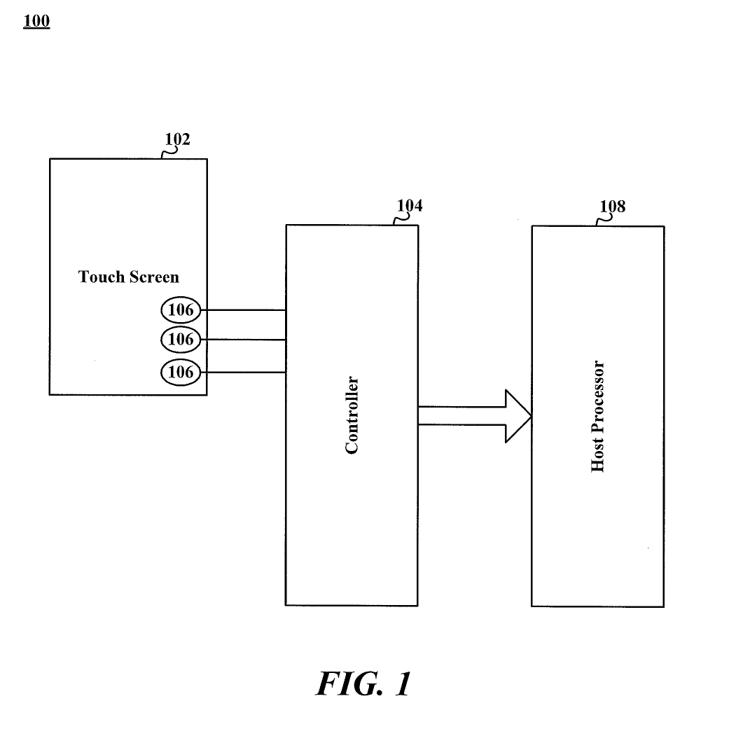

FIG. 1 is a diagram illustrating a system for determining the number and position of one or more touches made on a touch screen, consistent with some embodiments. As shown in FIG. 1, system 100 includes a touch screen 102 coupled to a controller 104. One or more touches 106 made on touch screen 102 may be sensed by sensors that make up touch screen 102, with the sensed touches 106 being interpreted by controller 104 for detecting a position of a touch 106 and, consistent with some embodiments, whether there are one or more touches 106. The interpreted touches are transmitted to host processor 108 which may use the interpreted touches to, for example, execute a program or perform an action.

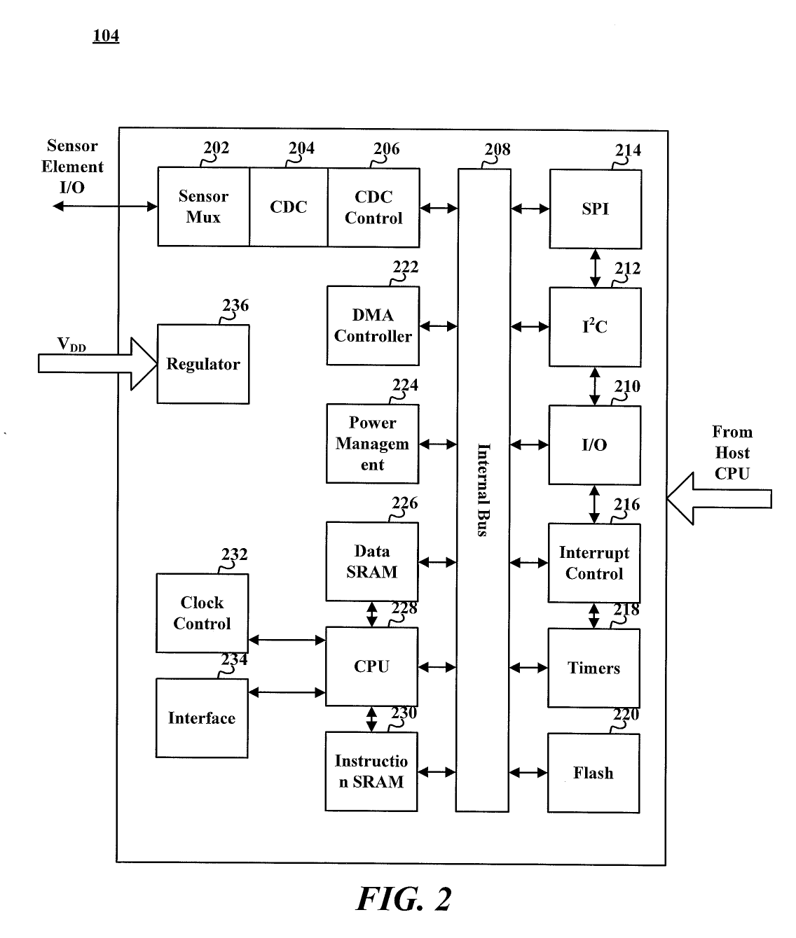

FIG. 2 is a diagram illustrating a controller, consistent with some embodiments. As shown in FIG. 2, controller 104 receives input from touch screen 102 representing one or more touches 106 in a sensor multiplexer (mux) 202. Consistent with some embodiments, touch screen 102 may include one or more capacitive touch sensors. According to such embodiments, controller 104 includes a capacitance-to-digital converter (CDC) 204 for receiving capacitance values from one or more touches 106 and converting the received capacitance values into a digital signal which is supplied to CDC control circuit 206 and then to internal bus 208. From internal bus 208, the digital signal produced from the capacitance values can be transmitted to host processor 108 through input/output (I/O) circuit 210, or through either or both of two-wire, or Inter-Integrated Circuit (I²C), bus 212 or three-wire, or Serial Peripheral Interface (SPI), bus 214. Controller 104 may further include an interrupt control circuit 216 coupled to I/O circuit 210 and internal bus 208, one or more timing circuits 218 coupled to interrupt control circuit 216 and internal bus 208, and non-volatile or flash memory 220 coupled to internal bus. Controller may also include a direct memory access (DMA) controller 222 coupled to internal bus 208, a power management circuit 224 coupled to internal bus 208, a data static random access memory (SRAM) 226 coupled to internal bus 208, a controller central processing unit (CPU) 228 coupled to internal bus 208 and data SRAM 226, and an instruction SRAM 230 coupled to controller CPU 228 and internal bus 208. Controller CPU 228 is coupled to clock control circuit 232 and interface circuit 234 for receiving clock signals. Controller 104 receives a power supply voltage V_{DD} at regulator 236. Consistent with some embodiments, controller CPU 228 executes instructions stored in instruction SRAM 230 to perform actions on digital signals produced from capacitance values stored in data SRAM 226. Such actions may include determining a position and number of one or more touches made on touch screen 102 coupled to controller 104.

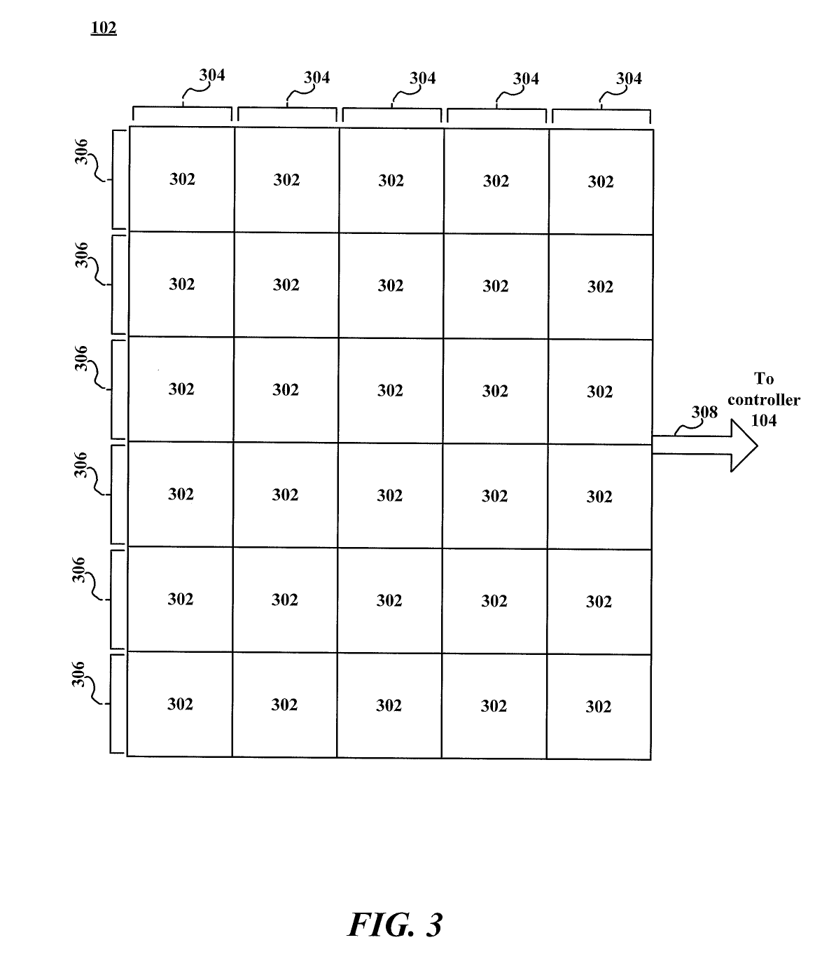

FIG. 3 is a diagram illustrating a touch screen, consistent with some embodiments. As shown in FIG. 3, touch screen 102 includes a plurality of touch sensors 302 arranged in a grid array having columns 304 and rows 306. Touch sensors 302 are coupled to controller 104 (shown in FIGS. 1 and 2) via coupling 308. Consistent with some embodiments, touch sensors 302 may be capacitive touch sensors which detect a change in capacitance caused by a human touch. Touch sensor 302 may also be single-layer capacitive touch sensors or multiple layer capacitive touch sensors. Although coupling 308 is shown as a single coupling between touch screen 102 and controller 104, in reality there are individual traces that make up coupling 308. If touch sensors 302 are multiple layer capacitive touch sensors, the traces that make up coupling 308 will be connected to each column 304 and row 306. If touch sensors 302 are single layer capacitive touch sensors, the traces that make up coupling 308 will be individually coupled to each touch sensor 302. Although FIG. 3 illustrates touch screen 102 having thirty touch sensors 302 arranged in a five column by six row array, touch screen may have any number of sensors in any arrangement.

Referring to FIGS. 1-3, in operation, controller CPU 228 may provide a command signal to CDC control circuit 206 to convert the capacitance values output from capacitive touch sensors 302 of touch screen 102, and store each value in data SRAM 226 until all capacitance values have been read from touch screen 102. These capacitance values may then be processed by controller CPU 228 to a position value that is output to host processor 108. The converted capacitance values may correspond to a position on a touch screen 102, or to control functions, such as, panning an image, selecting a displayed object, zooming in or out. Consistent with some embodiments, controller CPU 228 continuously reads converted capacitance values output from CDC 204 through CDC control circuit 206, but may only output a position value to host processor 108 when the position changes. In other words, host processor 108 may assume that a last reported position remains in effect until controller CPU 228 provides a position value to host processor 108 that is different than a previous position value.

Consistent with some embodiments, a position of user touches may be determined by individually considering each touch sensor 302. For example, the capacitance value of each of touch sensor 302 can be determined and controller CPU 228 can calculate a center of weight based on the capacitance values of each touch sensor 302. The calculated center of weight can provide an indication of the position of a user touch on touch screen 102. Although, using the center of weight calculations provides an accurate touch position in most cases, it can be difficult to resolve multiple touches. In particular, center of weight calculations may not accurately determine the positions of multiple touches.

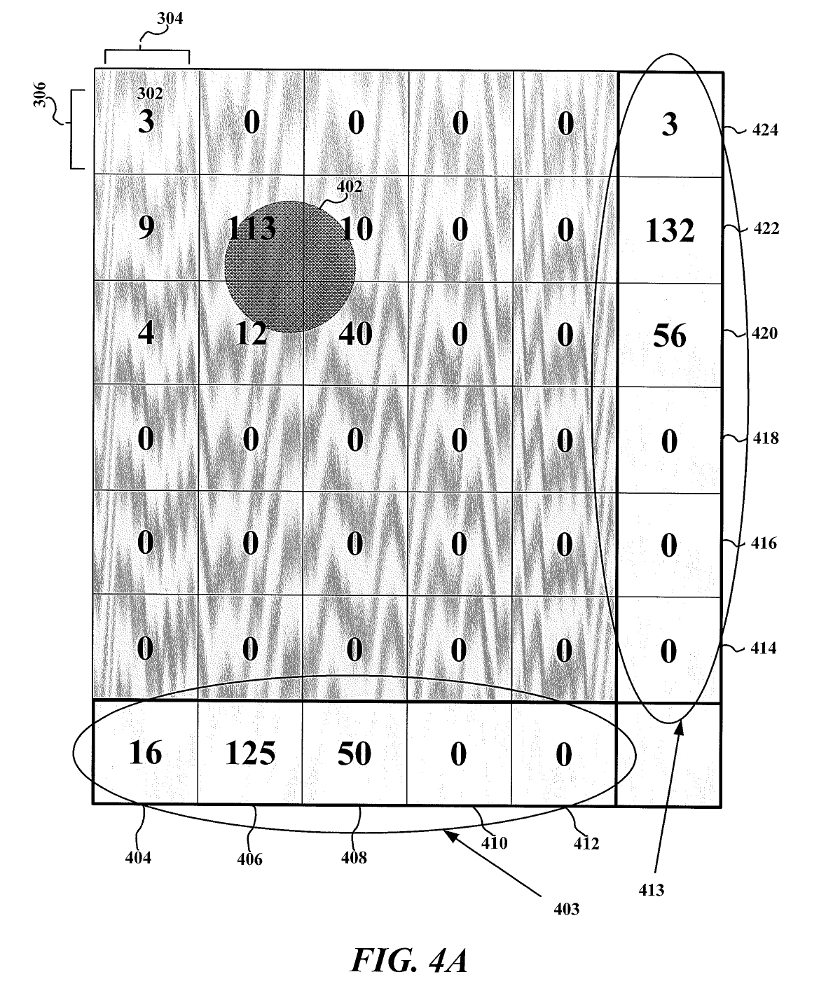

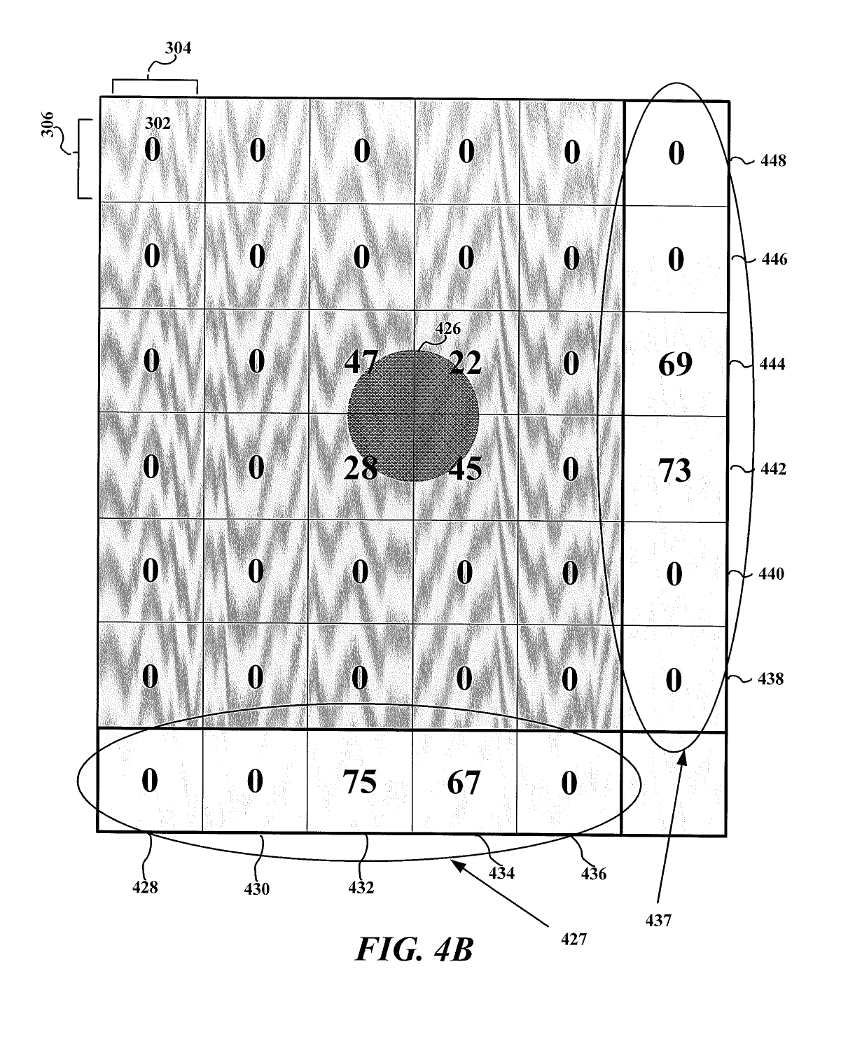

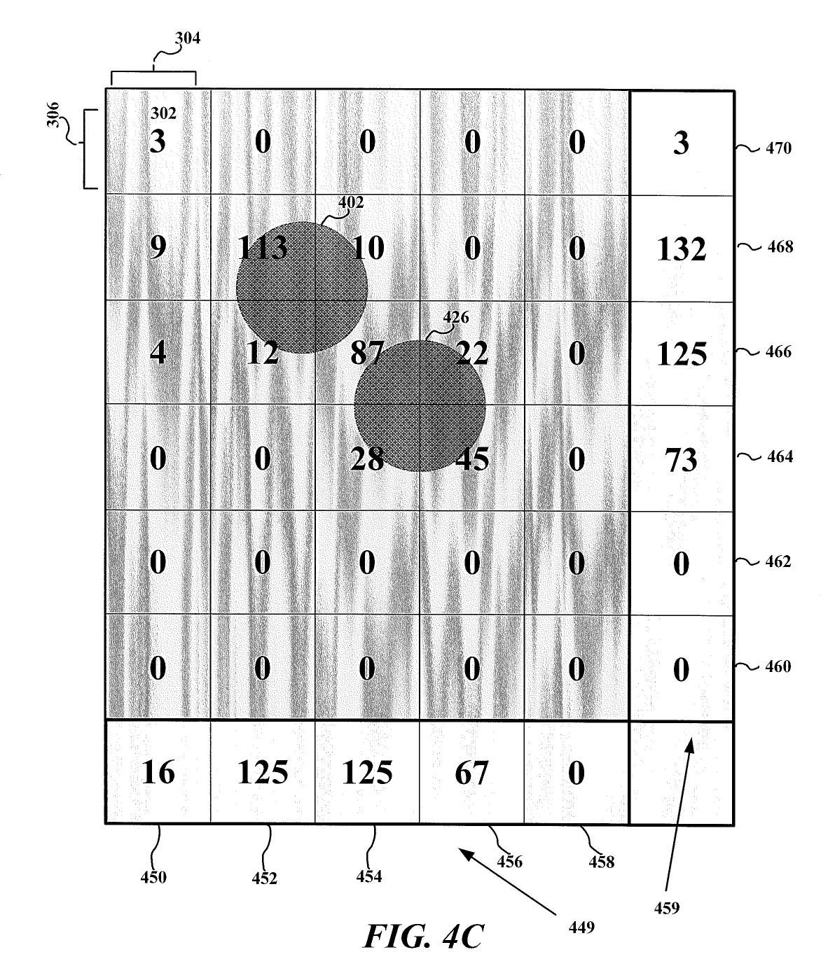

FIGS. 4A-4C are diagrams illustrating determining a number and position of one or more touches on a touch screen using vertical and horizontal sums, consistent with some embodiments. As shown in FIG. 4A, a first touch 402 is made on touch screen 102 in a manner that overlaps four touch sensors 302. Controller CPU 228 can calculate a capacitance value for each touch sensor 302 based on digital values produced by CDC 204 based on individual capacitance values of touch sensors 302. Consistent with some embodiments, controller CPU 228 can also calculate the sums of each column and row to produce a series 403 of vertical sums 404, 406, 408, 410 and 412 and a series 413 of horizontal sums, 414, 416, 418, 420, 422, and 424. Series 403 is referred to as a vertical sum because the summation made in each column 304 appears as a vertical calculation (3+9+4+0+0+0). Similarly, series 413 is referred to as a horizontal sum because the summation made in reach row 306 appears as a horizontal calculation (3+0+0+0+0). By calculating the horizontal and vertical sums of the individual touch sensors, controller CPU 228 does not have to determine a position and location of one or more touches by analyzing and computing a center of weight of each element. Instead, controller processor 228 is able to determine a position and number of one or more touches using a more limited number of data points.

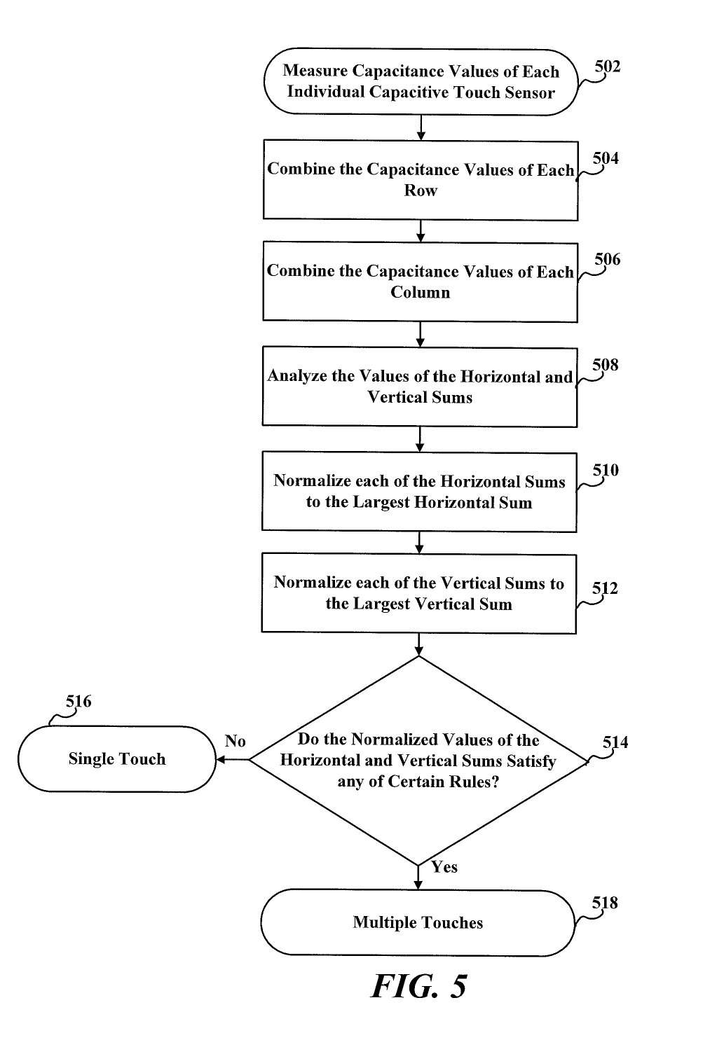

FIG. 4B shows a second touch 426 that also overlaps four touch sensors 302. From second touch 426 controller processor 228 can also calculate the sums of each column and row to produce a series 427 of vertical sums 428, 430, 432, 434, and 436, and a series 437 of horizontal sums, 438, 440, 442, 444, 446, and 448. FIG. 4C illustrates both first touch 402 and second touch 426, along with a series 449 of calculated vertical sums 450, 452, 454, 456, and 458 and a series 459 of horizontal sums, 460, 462, 464, 466, 468, and 470. Consistent with some embodiments, controller CPU 228 may be configured to calculate a position and/or number of touches made on a touch screen 102 using the calculated horizontal and vertical sums, as discussed in FIGS. 5, 6A-6G, and 7.

FIG. 5 is a flowchart illustrating a method for determining a number of touches made on a touch screen, consistent with some embodiments. FIG. 5 will be discussed with reference to FIGS. 1-3 and 4C for the purposes of illustration. The method begins by measuring capacitance values of each individual capacitive touch sensor 302 of touch screen (502). As discussed above, the measured capacitance value may then be converted to a digital value by CDC 204 and stored in data SRAM 226. Controller CPU 228 then executes instructions stored in instruction SRAM 230 to calculate a series 459 of horizontal sums by combining the stored capacitance values of each row 306 (504). Controller CPU 228 then executes instructions stored in instruction SRAM 230 to calculate a series 449 of vertical sums by combining the stored capacitance values of each column 304 (506). Controller CPU 228 then executes instructions stored in instruction SRAM 230 to assign weighting factors to normalize the series 459 of horizontal sums to the largest horizontal sum (508). Controller CPU 228 then executes instructions stored in instruction SRAM 230 to normalize the series 449 of vertical sums to the largest vertical sum (510) Controller CPU 228 then executes instructions stored in instruction SRAM 230 to analyze the relative values of the series 449 of normalized vertical sums and the series 459 of normalized horizontal sums (512). Consistent with some embodiments, analysis of the values of the normalized horizontal and vertical sums including applying one or more rules to the normalized horizontal and vertical sums (514). The one or more rules may be stored as instructions in instruction SRAM 230 for execution by controller CPU 228. If the relative values of the normalized horizontal and vertical sums do not satisfy any of the one or more of the applied rules, controller CPU 228 may determine that only a single touch has been made on touch screen 102 (516). On the other hand, if the relative values of the normalized horizontal and vertical sums do satisfy one or more applied rules, controller CPU 228 may determine that multiple touches have been made on touch screen 102 (518).

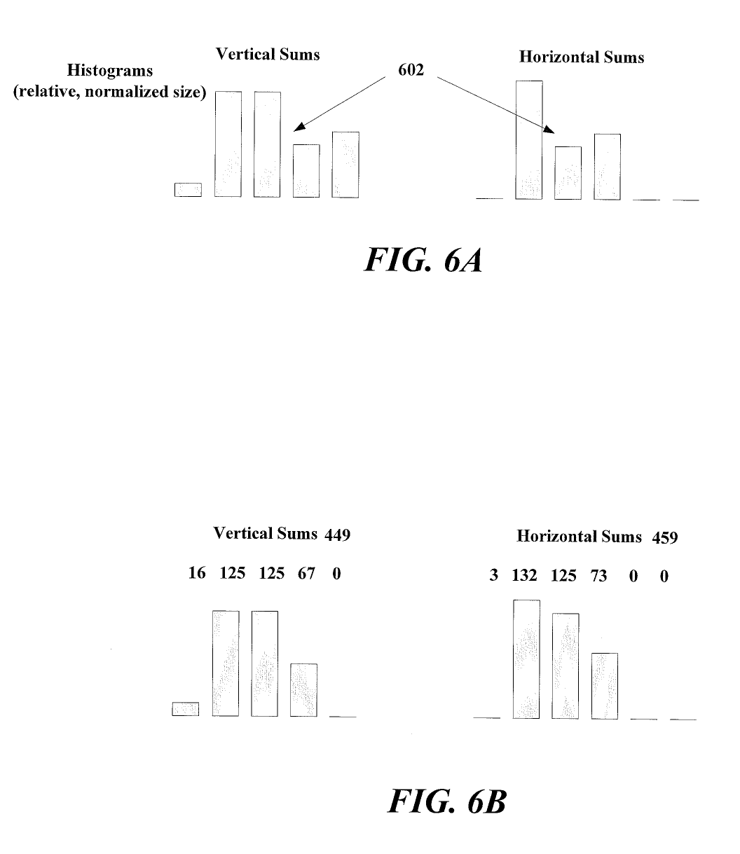

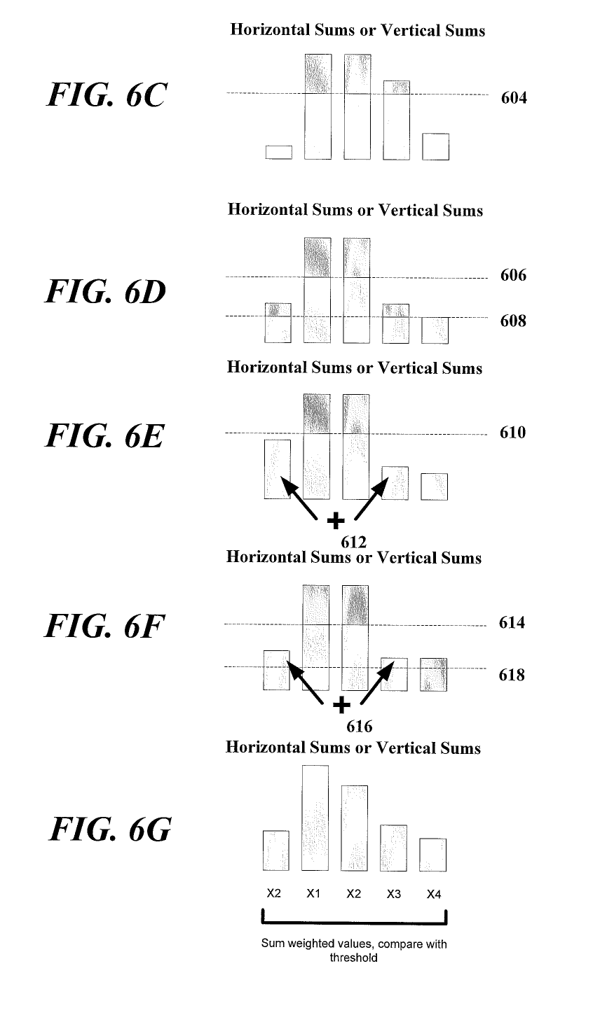

FIGS. 6A-6G illustrate some of the rules that may be applied to the vertical and horizontal sums for determining a number of touches made on a touch screen, consistent with some embodiments. Consistent with some embodiments, the rules illustrated in FIGS. 6A-6G may be applied in step 510 of FIG. 5, discussed above. For the purposes of illustration, FIGS. 6A-6G show the normalized values of horizontal and vertical sums as a histogram to illustrate the relative values of the normalized horizontal and vertical sums calculated for each row 306 and column 304. FIG. 6A illustrates one rule for determining a number of touches made on a touch screen consistent with some embodiments. According to the rule illustrated in FIG. 6A, if there is a valley 602 representing a lower value between adjacent vertical sums or horizontal sums, CPU controller 228 will determine that at least two touches are being made on touch screen. That is, if the normalized value of a vertical sum of a first column or a horizontal sum of a first row is less than the normalized values of the vertical sums of adjacent columns or adjacent rows, CPU controller 228 will determine that multiple touches are determined on touch screen 102. Consistent with some embodiments, touches may correspond to two touches. FIG. 6A is considered to be a trivial case as all well-separated multiple touches correspond to this case and is shown here for illustration. However, FIG. 6B illustrates a histogram representing the series 449 of vertical sums and the series 459 of horizontal sums shown in FIG. 4C. As is clear from analyzing FIG. 6B, there is no “valley” between adjacent vertical sums or horizontal sums. FIGS. 6C-6G will illustrate rules to be applied for series of vertical and horizontal sums that do not have a valley, such as FIG. 4C.

FIGS. 6C-6G illustrate normalized values of either horizontal sums or vertical sums for hypothetical capacitance values obtained using methods and systems and described herein. For the purposes of illustrating the relative value of the normalized values, horizontal or vertical sums are shown as a histogram in FIGS. 6C-6G. FIG. 6C illustrates a rule that multiple touches may be detected when there are more than two horizontal sums or vertical sums that are above a predetermined threshold 604, which may be different for the horizontal and vertical sums. Consistent with some embodiments, threshold 604 may be set based on the number of horizontal touch sensors 302, the number of vertical touch sensor 302, or the size of touch sensor 302. FIG. 6D illustrates a rule wherein multiple touches may be determined when there are two horizontal or vertical sums that are greater than a first threshold 606 and two horizontal or vertical sums that are greater than a second threshold 608, wherein second threshold 608 is less than first threshold 606. Consistent with some embodiments, first threshold 606 and second threshold 608 may be set based on the number of horizontal touch sensors 302, the number of vertical touch sensor 302, or a size of touch sensor 302.

FIG. 6E illustrates a rule wherein multiple touches may be determined when there are two horizontal or vertical sums above a first threshold 610 and a sum 612 of two other horizontal or vertical sums are above a second threshold (not shown). Consistent with some embodiments, first threshold 610 and the second threshold may be set based on the number of horizontal touch sensors 302, the number of vertical touch sensor 302, or the size of touch sensor 302. Moreover, first threshold 610 and the second threshold may be different for applying the rule to horizontal or vertical sums. FIG. 6F illustrates a rule wherein multiple touches may be determined when there are two horizontal or vertical sums above a first threshold 614 and a of sum 616 of two other horizontal or vertical sums are less than a second threshold (not shown), and one more horizontal or vertical sum is above a third threshold 618. Consistent with some embodiments, first threshold 614, second threshold 616, and third threshold 618 may be set based on the number of horizontal touch sensors 302, the number of vertical touch sensor 302, or the size of touch sensor 302. Moreover, first threshold 614 and second threshold 616 may be different for applying the rule to horizontal or vertical sums. FIG. 6G illustrates a rule that horizontal or vertical sums assigned weighting factors based on a distance from the horizontal or vertical sum having the largest value. The weighted values of the horizontal and vertical sums are then added together and multiple touches may be determined when the sum of the weighted values is greater than a threshold (not shown). Although the rules illustrated in FIGS. 6A and 6C-6F provide methods for a controller CPU 228 to determine if multiple touches have been made on touch screen 102, these rules are not exhaustive. Indeed, other rules may be applied to determine multiple touches, consistent with other embodiments.

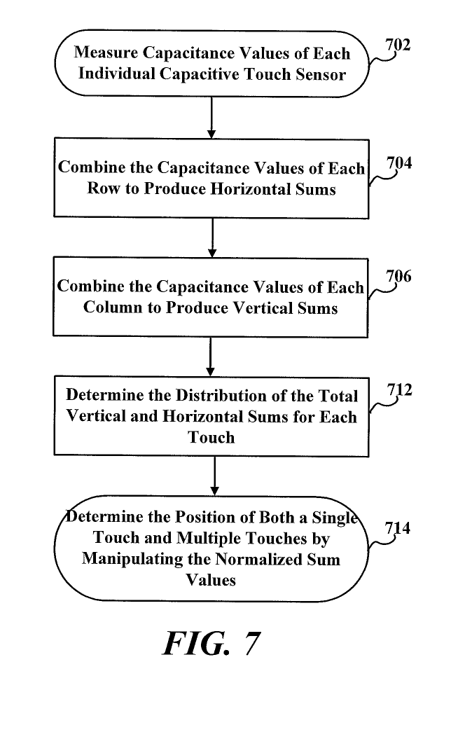

FIG. 7 is a flowchart illustrating a method for determining a position of one or more touches on a touch screen device consistent with some embodiments. FIG. 7 will be discussed with reference to FIGS. 1-3 and 4C for the purposes of illustration. The method begins by measuring capacitance values for each capacitive touch sensor 302 of touch screen 102. As discussed above, the measured capacitance value may then be converted to a digital value by CDC 204 and stored in data SRAM 226. Controller CPU 228 then executes instructions stored in instruction SRAM 230 to calculate a series 459 of horizontal sums by combining the stored capacitance values of each row 306 (704). Controller CPU 228 then executes instructions stored in instruction SRAM 230 to calculate a series 449 of vertical sums by combining the stored capacitance values of each column 304 (706). Next, controller CPU 228 executes instructions stored in instruction SRAM 230 to determine a distribution of the series 449 of vertical sums and the series 459 of horizontal sums for each touch of the one or more touches made on touch screen 102 (708). The determined distribution may be considered to be a weight of each touch made on touch screen 102. Controller CPU 228 may then execute instructions stored in instruction SRAM 230 to determine a position of both a single touch and multiple touches by manipulating the sum values (714). Consistent with some embodiments, the location of the first touch of a possible multiple touches may be calculated by performing a center of weight calculation on a partial set of the horizontal and vertical sums, the partial set being calculated by summing the horizontal and vertical sums starting at the first value of the horizontal and vertical sums, and ending when the total weight of that touch (determined in step 708) has been included. The second of the possible multiple touches is then calculated using a similar method but being calculated by summing the horizontal and vertical sums starting at the last value of the horizontal and vertical sums and ending when the total weight of that touch (determined in step 708) has been included. Consistent with some embodiments, the “first value” may be considered to be a left-most vertical sum or a top-most horizontal sum, while a “last value” may be considered to be a right-most vertical sum or a bottom-most horizontal sum. A separation line between the two touches will, in general, be partially within one of the horizontal or vertical sums. A single touch may also be calculated using a center of weight method using all of the normalized horizontal and vertical sums. Although embodiments disclosed herein in conjunction with FIG. 7 are described as being performed by controller CPU 228 based on instructions stored in instruction SRAM 230, the embodiment is not so limiting. Indeed, any processing device may execute similar instructions to calculate a position of multiple touches using the method described herein.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. Some common forms of machine-readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Embodiments as disclosed herein may provide a system and method for determining the position and number of touches made on a touch screen device. In particular, the system and method disclosed herein calculates horizontal and vertical sums by combining the sensor values of all of the sensors in each row and column of the touch sensors in the touch screen device. The calculated horizontal and vertical sums may then be used to determine both the number of touches made on a touch screen device as well as the position of both touches. By using the calculated horizontal and vertical sums, the number of data points for analyzing to determine the position and number of touches is reduced over methods and systems that use every sensor value from every sensor in the touch screen. This provides for a system and method that offers significant advantages and simplicity over conventional methods and systems. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A method of determining a number of touches made on a capacitive touch screen device having capacitive touch sensor elements arranged in columns and rows, comprising:
measuring, by individual capacitive touch sensor elements of the touch screen device, capacitance values for each of the capacitive touch sensor elements;
combining, by a controller central processing unit (CPU) of the capacitive touch screen device, the capacitance values of each row of individual capacitive touch sensor to produce a horizontal sum of the capacitance values for each row;
combining, by the controller CPU, the capacitance values of each column of individual capacitive touch sensor to produce a vertical sum of the capacitance values for each column;
determining, by the controller CPU, a largest value of the horizontal sums and the vertical sums;
normalizing, by the controller CPU, the values of the vertical sums to the determined largest vertical sum and the values of the horizontal sums to the determined largest horizontal sum;
applying, by the controller CPU, one or more rules to the normalized horizontal and vertical sums to determine the number of touches made on the capacitive touch screen device.

2. The method of claim 1, wherein applying one or more rules comprises:
analyzing, by the controller CPU, the normalized values of the horizontal and vertical sums; and
determining, by the controller CPU, if the normalized value of a horizontal sum of a first row is less than the normalized value of horizontal sums of both adjacent rows, wherein
if the normalized value of the horizontal sum of the first row is less than the normalized value of the horizontal sums of both adjacent rows, determining that multiple touches were detected on the touch screen.

3. The method of claim 1, wherein applying one or more rules comprises:
analyzing, by the controller CPU, the normalized values of the horizontal and vertical sums; and
determining, by the controller CPU, if the normalized value of a vertical sum of a first column is less than the normalized value of vertical sums of both adjacent column, wherein
if the normalized value of the vertical sum of the first column is less than the normalized value of the vertical sum of both adjacent columns, determining that multiple touches were detected on the touch screen.

4. The method of claim 1, wherein applying one or more rules comprises:
analyzing, by the controller CPU, normalized values of the horizontal and vertical sums; and
determining, by the controller CPU, if the normalized values of more than two vertical sums or horizontal sums are greater than a predetermined threshold value, wherein
if the normalized values of more than two vertical sums or horizontal sums are greater than the predetermined threshold value, determining that multiple touches were detected on the touch screen.

5. The method of claim 1, wherein applying one or more rules comprises:
analyzing, by the controller CPU, the normalized values of the horizontal and vertical sums;
determining, by the controller CPU, if the normalized values of first and second vertical sums or horizontal sums are greater than a first predetermined threshold value; and
determining, by the controller CPU, if the normalized values of third and fourth vertical sums or horizontal sums are greater than a second predetermined threshold, wherein
if the normalized values of first and second vertical sums or horizontal sums are greater than the first predetermined threshold value and the normalized values of third and fourth vertical sums or horizontal sums are greater than the second predetermined threshold, determining that multiple touches were detected on the touch screen.

6. The method of claim 5, wherein the second predetermined threshold is less than the first threshold.

7. The method of claim 1, wherein applying one or more rules comprises:
analyzing, by the controller CPU, the normalized values of the horizontal and vertical sums;
determining, by the controller CPU, if the normalized values of first and second vertical sums or horizontal sums are greater than a first predetermined threshold value; and
determining, by the controller CPU, if a sum of the normalized values of third and fourth vertical sums or horizontal sums are greater than a second predetermined threshold, wherein
if the normalized values of first and second vertical sums or horizontal sums are greater than the first predetermined threshold value and the sum of the normalized values of third and fourth vertical sums or horizontal sums are greater than the second predetermined threshold, determining that multiple touches were detected on the touch screen.

8. The method of claim 1, wherein applying one or more rules comprises:
analyzing, by the controller CPU, the normalized values of the horizontal and vertical sums;
determining, by the controller CPU, if the normalized values of first and second vertical sums or horizontal sums are greater than a first predetermined threshold value;
determining, by the controller CPU, if a sum of the normalized values of third and fourth vertical sums or horizontal sums are less than a second predetermined threshold; and
determining, by the controller CPU, if the value of a fifth vertical or horizontal sum is greater than a third predetermined threshold, wherein
if the normalized values of first and second vertical sums or horizontal sums are greater than the first predetermined threshold value, the sum of the normalized values of third and fourth vertical sums or horizontal sums are less than the second predetermined threshold, and the normalized value of a fifth vertical or horizontal sum is greater than a third predetermined threshold, determining that multiple touches were detected on the touch screen.

9. The method of claim 1, wherein normalizing the values of the horizontal sums comprises:
assigning, by the controller CPU, weighting factors to the values of the horizontal sums based on a distance from their respective rows to the row having the largest horizontal sum to produce weighted values; and
applying one or more rules comprises:
adding, by the controller CPU, the weighted values; and
determining, by the controller CPU, if the added weighted values are greater than a predetermined threshold, wherein
if the added weighted values are greater than the predetermined threshold, determining that multiple touches were detected on the touch screen.

10. The method of claim 1, wherein normalizing the values of the vertical sums comprises:
assigning, by the controller CPU, weighting factors to the values of the vertical sums based on a distance from their respective columns to the column having the largest vertical sum to produce weighted values; and
applying one or more rules comprises:
adding, by the controller CPU, the weighted values; and
determining, by the controller CPU, if the added weighted values are greater than a predetermined threshold, wherein
if the added weighted values are greater than the predetermined threshold, determining that multiple touches were detected on the touch screen.

11. A method for determining a position of one or more touches made on a capacitive touch screen device having capacitive touch sensor elements arranged in columns and rows, comprising:
measuring, by individual capacitive touch sensor elements of the touch screen device, capacitance values for each of the capacitive touch sensor elements;
combining, by a controller central processing unit (CPU) of the capacitive touch screen device, the capacitance values of each row of individual capacitive touch sensor to produce a horizontal sum of the capacitance values for each row;
combining, by the controller CPU, the capacitance values of each column of individual capacitive touch sensor to produce a vertical sum of the capacitance values for each column;
determining, by the controller CPU, a distribution of the vertical and horizontal sums for each touch; and
determining, by the controller CPU, a position of a single touch and multiple touches by manipulating the sum values.

12. The method of claim 11, wherein manipulating the sum values comprises:
calculating, by the controller CPU, a center of weight calculation on a partial set of the horizontal and vertical sum values.

13. The method of claim 12, wherein the partial set of the horizontal and vertical sum values comprises a set of horizontal and vertical sums having a sum that is equal to the distribution of the horizontal and vertical sums for each touch.

14. The method of claim 13, wherein the sum is calculated from a first horizontal or vertical sum for a first touch, and from a last horizontal or vertical sum for a second touch.

15. A circuit for determining the number and position of one or more touches made on a touch screen device having a plurality of capacitive touch sensor elements arranged in rows and columns and coupled to the circuit, comprising:
a sensor multiplexer configured to receive capacitance values from the plurality of capacitive touch sensor elements;
a capacitance-to-digital converter circuit configured to convert the received capacitance values to digital values; and
a controller central processing unit (CPU) configured to:
combine the capacitance values of each row of individual capacitive touch sensor to produce a horizontal sum of the capacitance values for each row;
combine the capacitance values of each column of individual capacitive touch sensor to produce a vertical sum of the capacitance values for each column; and
determine a number and position of one or more touches made on the touch screen device using the horizontal sums and the vertical sums.

16. The circuit of claim 15, wherein the controller CPU is further configured to:
normalize the values of the vertical sums to the largest vertical sum and normalize the values of the horizontal sums to the largest horizontal sum;
apply one or more rules to the normalized horizontal and vertical sums to determine the number of touches made on the capacitive touch screen device;
determine a distribution of the vertical and horizontal sums for each touch; and
determine a position of a single touch and multiple touches by manipulating the sum values.

17. The circuit of claim 16, wherein the controller CPU is further configured to:
calculate a center of weight calculation on a partial set of the horizontal and vertical sum values, wherein the partial set of the horizontal and vertical sum values comprises a set of horizontal and vertical sums having a sum that is equal to the distribution of the horizontal and vertical sums for each touch.

18. The circuit of claim 16, wherein applying one or more rules comprises:
analyzing the normalized values of the horizontal and vertical sums; and
determining if the normalized value of a horizontal sum of a first row is less than the normalized value of horizontal sums of both adjacent rows or if the normalized value of a vertical sum of a first column is less than the normalized value of vertical sums of both adjacent columns.

19. The circuit of claim 16, wherein applying one or more rules comprises:
analyzing normalized values of the horizontal and vertical sums; and
determining if the normalized values of more than two vertical sums or horizontal sums are greater than a threshold value.

20. The circuit of claim 16, wherein normalizing the values of the vertical and horizontal sums to the largest vertical and horizontal sum comprises:
assigning weighting factors to the values of the horizontal sums based on a distance from their respective rows to the row having the largest horizontal sum to produce weighted row values; and
assigning weighting factors to the values of the vertical sums based on a distance from their respective columns to the column having the largest vertical sum to produce weighted column values; and
applying one or more rules comprises:
summing the weighted column values and summing the weighted row values; and
determining if the summed weighted column values or the summed weighted row values are greater than a threshold.
